(19) United States
(12) Patent Application Publication
(10) Pub. No.: US 2009/0235197 A1
(43) Pub. Date: Sep. 17, 2009

(54) SYSTEM AND METHOD FOR PASSWORD ENTRY

(75) Inventors: WEN-MING CHEN, Shenzhen City (CN); WANG-CHANG DUAN, Shenzhen City (CN); BANG-SHENG ZUO, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/402,507

(22) Filed: Mar. 12, 2009

(30) Foreign Application Priority Data
Mar. 14, 2008 (CN) 200810300583.4

(51) Int. Cl. G06F 3/048; H04L 9/32; G06F 21/00; G06F 17/30

(52) U.S. Cl. 715/780; 726/7; 707/3; 345/173; 707/E17.061

(57) ABSTRACT

An exemplary system and method are provided for password entry using a touch screen. The method includes displaying a password input interface having a first field and a second field, receiving first inputs from the touch screen for entering a user account into the first field, displaying traces images converted from the first inputs corresponding to the user account, receiving second inputs from the touch screen for entering user account into the first field, and modifying the second inputs so as to disable displaying residual imprints or trace characters corresponding to the password.

### BACKGROUND

1. Technical Field

The present disclosure relates to passwords, and more particularly to a system and a method for password entry using a touch-activated device.

2. Description of Related Art

Touch-activated devices, such as touch screens, are combined input/output devices allowing input of data and/or instructions and outputting information as a result of the input. These input/output devices include computers, cellular phones, and the like. A touch screen generally includes a display screen and a touch sensitive screen. The touch sensitive screen receives inputs from a user's finger or a stylus. In response to the inputs, the display screen may display residual imprints or trace characters corresponding to the inputted characters for a few seconds.

However, when the touch screen is used for entering a password, it is possible that an unauthorized observer may note such residual trace characters and discern the password. That is, the conventional system and method for password entry, on touch screens, is not very secure.

Therefore, it is desired to provide a system and method for overcoming the described shortcomings and deficiencies.

### BRIEF DESCRIPTION OF THE DRAWINGS

FIG. 1 is a block diagram of system for password entry in accordance with an exemplary embodiment.

FIG. 2a is a schematic diagram showing a password input interface generated by the system of FIG. 1 in accordance with the exemplary embodiment, with the password input interface configured in a first state.

FIG. 2b is a schematic diagram showing the password input interface of FIG. 2a configured in a second state.

FIG. 3 is a flowchart of a method for password entry in accordance with an exemplary embodiment.

### DETAILED DESCRIPTION

The present disclosure provides a novel and unobvious feature of disguising residual trace characters corresponding to user inputs such that the residual imprints or trace characters cannot be recognized as displayed. As used herein, residual imprints or trace characters are generated exactly corresponding to handwritten traces, motions and/or movements of a user's finger and/or a stylus on a touch sensitive screen. The residual imprints or trace characters are typically displayed accompanying or after inputs for a few seconds. As used herein, disguising the traces includes replacement or disablement of the residual imprints or trace characters. Accordingly, an unauthorized observer cannot easily discern the password by looking for residual imprints or trace characters. Another novel and unobvious feature is that at least two separate character databases including an alphabet character database and a numeric character database are configured independently for identifying the inputs. By such a configuration, the inputs can be more accurately identified. More detail with regard to the above mentioned novel and unobvious features will be described hereinafter.

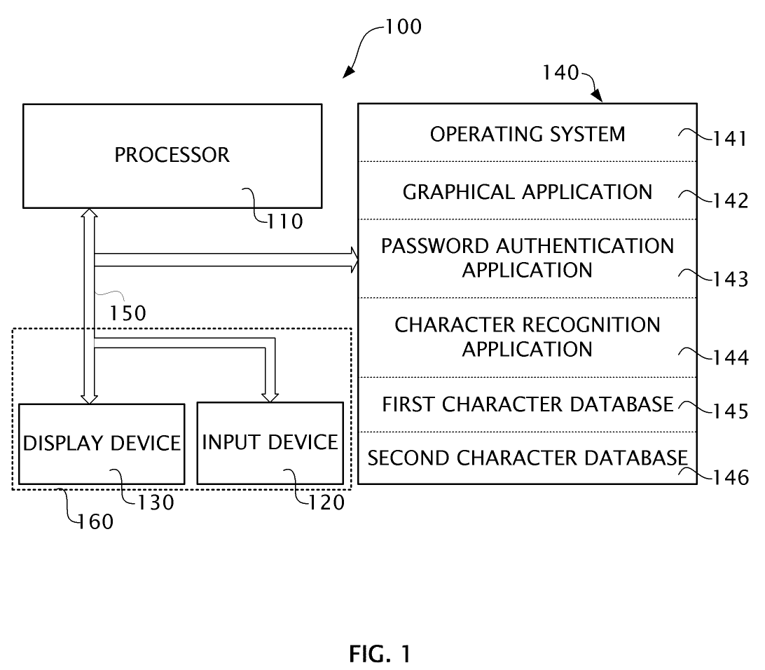

Referring to FIG. 1, a block diagram of a system 100 in accordance with an exemplary embodiment is shown. The system 100 includes a processor 110, an input device 120, a display device 130, a storage device 140, all interconnected by a bus 150. The processor 110 executes program instructions stored in the storage device 140, and controls operations of the system 100. The storage device 140 includes one or more types of memory including Read Only Memory (ROM) and Random-Access Memory (RAM). The storage device 140 stores an operating system 141, a graphical application 142, a password authentication application 143, a character recognition application 144, a first character database 145, and a second character database 146.

The input device 120 may be a touch screen including an array of sensors (not shown). The display device 130 may be a liquid crystal display (LCD). In the embodiment, the input device 120 and the display device 130 are shown separately for description convenience. Actually, the input device 120 and the display device 130 are integrated together to form a combined input/output device. The sensors of the input device 120 may receive inputs or physical contacts from a user's finger and/or stylus via the input device 120. The inputs or physical contacts between the input device 120 and the user's finger and/or stylus are converted to electrical signals. The input device 120 transmits the electrical signals to the processor 110.

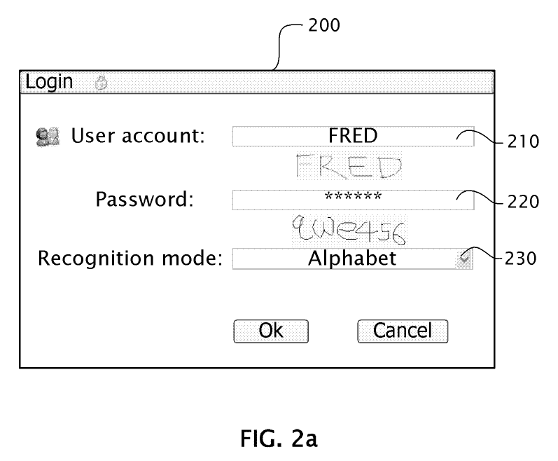

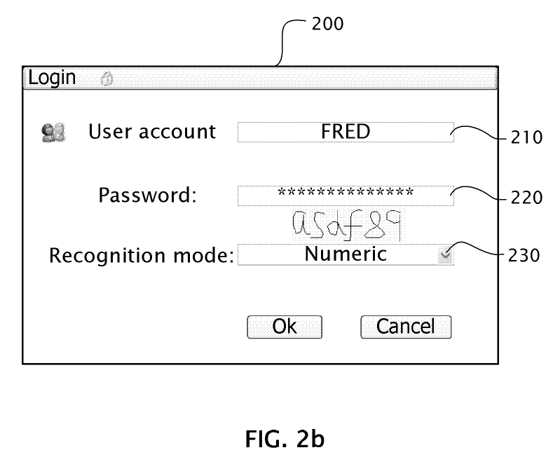

The processor 110 processes the electrical signals transmitted from the input device 120, and may cause the display device 130 to display residual imprints or trace characters when there are inputs or physical contacts. The processor 110 implements the graphical application 142 to provide a password input interface 200 (see FIG. 2a and FIG. 2b) in the display device 130. Referring to FIG. 2a and FIG. 2b, the password input interface 200 includes a first field 210 for inputting a user account name, a second field 220 for inputting a password corresponding to the user account, and a drop-down list 230 from which a recognition mode is selected for recognizing the inputs or physical contacts. The recognition mode includes an alphabet mode and a numeric mode. The drop-down list 230 provides an option by which one of the first character database 145 or the second character database 146 may be selected correspondingly for accurate translation of the inputs or physical contacts. In other embodiments, the drop-down list 230 can be replaced by some other form of mode selection item, such as a check-box field.

In operation, the first field 210 may be activated to receive user account name from the input device 120. In this example, the name of the user account name is “FRED”. The input may be manually entered and the residual imprints or trace characters corresponding to the user account appear on the input device 120. At the same time, the residual imprints or trace characters of “FRED” are displayed in the display device 130. The processor 110 implements the character recognition application 144 in the storage device 140 to convert the residual imprints or trace characters of “FRED” to regular characters “FRED”. The regular characters “FRED” are not disguised and are literally displayed in the first field 210.

After the first field 210 receives the user account name “FRED”, the second field 220 may be activated to receive password also from the input device 120. In this example, the password is “ijkxyz19831122”. The password is preset corresponding to the user account “FRED”. The input may be manually entered and disguised residual imprints or trace characters appear on the display device 130. In one embodiment, the disguised residual imprints or trace characters may be “qwe456asdf89”. In another embodiment, the residual imprints or trace characters may be totally disabled being displayed.

The password “ijkxyz19831122” can be divided into two portions, a first portion only having alphabet characters of “ijkxyz” and a second portion only having numeric characters of “19831122”.

When the first portion “ijkxyz” is manually input via the input device 120, the alphabet mode is selected by activating the drop-down list 230. In this case, the processor 110 implements the character recognition application 144 in the storage device 140 to only locate alphabet characters most closely matching inputs from the first character database 145. The display device 130 does not literally display regular alphabet characters of the first portion “ijkxyz” in the second field 220. In practice, the first portion “ijkxyz” is typically not displayed, and replaced by “******”.

When the second portion “19831122” is manually input via the input device 120, the numeric mode is selected by activating the drop-down list 230. In this case, the processor 110 implements the character recognition application 144 in the storage device 140 to only locate numeric characters most matching inputs from the second character database 146. The display device 130 does not literally display regular numeric characters of the second portion “19831122” in the second field 220. In practice, the second portion “19831122” is also typically not displayed, and replaced by “********”.

After the user account and password are input, an icon “OK” displayed in the password input interface 200 may be activated. Then, the processor 110 implements the password authentication application 143 in the storage device 140 to authenticate the user account, so as to allow a user to enter the system 100.

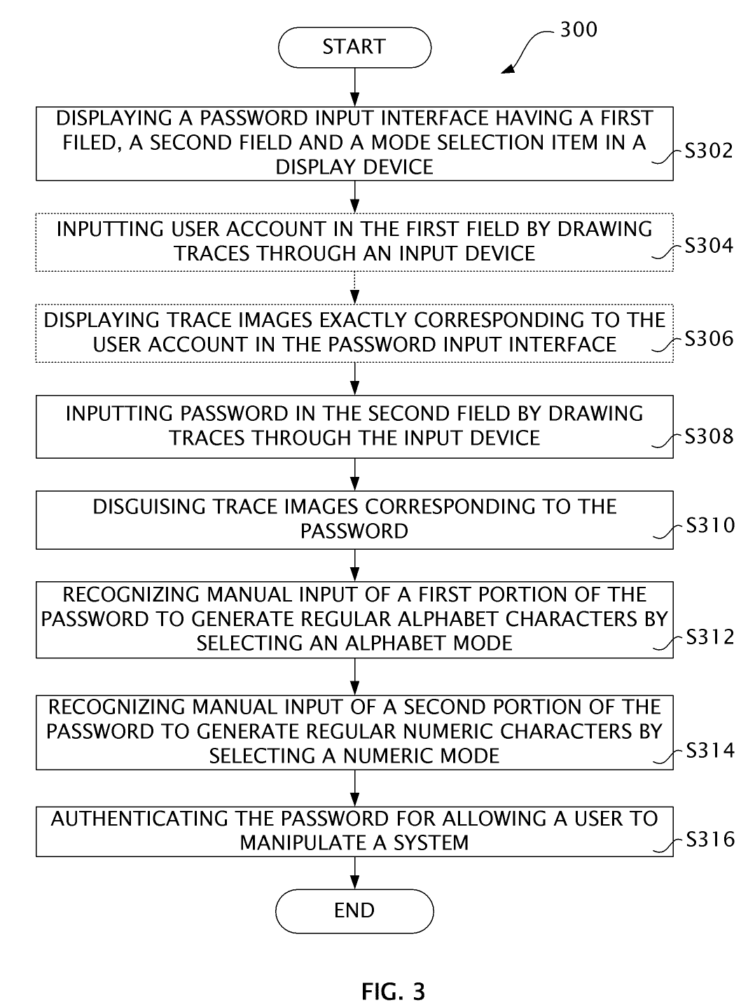

Referring to FIG. 3, a flowchart illustrating a method 300 for password entry is shown. The method 300 includes the following blocks, each of which is tied to various devices contained in the system 100 as shown in FIG. 1.

At block S302, the display device 130 displays a password input interface 200 by implementing a graphical application 142 stored in a storage device 140 of the system 100. The password input interface 200 includes a first field 210, a second field 220, and a drop-down list 230.

At block S304, the input device 120 receives inputs or physical contacts so as to input a user account name, for example “FRED” in the first field 210 via the input device 120.

At block S306, the display device 130 displays residual imprints or trace characters corresponding to the user account, and regular characters in the first field 210 of the password input interface 200.

At block S308, the input device 120 receives inputs or physical contacts so as to input password, for example “ijkxyz19831122” in the second field 220 via the input device 120. The password includes a first portion only having alphabet characters and a second portion only having numeric characters. During entering the password, in one embodiment, the residual imprints or trace characters are disguised, such that disguised residual imprints or trace characters of “qwe456asdf89” are displayed. In other embodiment, the residual imprints or trace characters may be totally disabled, as such, the residual imprints or trace characters are not displayed in the display device 130.

At block S310, the processor 110 of the system 100 implements a character recognition application 144 in the storage device 140 to recognize the first portion of alphabet characters of the password, and generate regular alphabet characters. The regular alphabet characters are only located from a first character database 145. The regular alphabet characters are typically not displayed and replaced by “********” in the second field 220 of the password input interface 200.

At block S312, the processor 110 implements the character recognition application 144 in the storage device 140 to recognize the second portion of numeric characters of the password, and generate regular numeric characters. The regular numeric characters are only located from a second character database 146. The regular numeric characters are also typically not displayed and replaced by “********” in the second field 220 of the password input interface 200.

At block S314, the processor 110 implements a password authentication application 143 in the storage device 140 to authenticate the user account for allowing a user to enter the system 100.

It should be noted that the various blocks in the method 300 illustrated in FIG. 3 may be performed in the order presented, or may be performed in a different order. Furthermore, in some embodiments, some blocks can be canceled from the method 300.

For example, the blocks S304 and S306 can be omitted from the method 300, if the user account is pre-displayed in the first field 210 of the password input interface 200 by default settings. In this case, only a password needs to be entered in the second field 220 of the password input interface 200.

For another example, the order of blocks S310 and S312 can be reversed, if the password is preset to be “19831122ijkxyz” with the numeric characters “19831122” appearing before the alphabet characters “ijkxyz”. In this case, at block S310, the numeric characters are recognized, and regular numeric characters are generated correspondingly. At block S312, the alphabet characters are recognized, and regular alphabet characters are generated correspondingly.

As described, during password entry using the system 100 and method 300, residual imprints or trace characters representing the inputs or physical contacts are disguised or totally disabled. In such a configuration, an unauthorized observer cannot easily discern the password.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A system for password entry, the system comprising:
a touch-sensitive input device configured to receive inputs;
a display device configured to display information;
a storage device configured to store a graphical application, a character recognition application, a first character database, and a second character database; and
a processor operatively connected to the input device, the display device, and the storage device, the processor implementing the graphical application to cause a password input interface comprising a field for input of password and a mode selection item to be displayed in the display device, the processor implementing the character recognition application to recognize characters in the password;
wherein when the mode selection item is activated to cause an alphabet recognition mode to be selected, the processor recognizes a first portion of alphabet characters in the password to only locate alphabet characters from the first character database, when the mode selection item is activated to cause a numeric recognition mode to be selected, the processor recognizes a second portion of numeric characters in the password to only locate numeric characters from the second character database.

2. The system according to claim 1, wherein the first character database and the second database are separately configured to be stored in the storage device.

3. The system according to claim 1, wherein the input device and the output device are integrated together to form a combined input/output device.

4. The system according to claim 3, wherein the input device is a touch screen.

5. The system according to claim 4, wherein the password input interface further comprises a field for input of a user account, the display device displays residual imprints or trace characters corresponding exactly to the user account when the user account is input through the touch screen.

6. The system according to claim 5, wherein the residual imprints or trace characters corresponding to the password are disguised when the password is input through the touch screen, so that the displayed trace characters are different from the actual character input.

7. The system according to claim 5, wherein the residual imprints or trace characters corresponding to the password are totally disabled, so as to disable displaying the residual imprints or trace characters corresponding to the password in the display device.

8. The system according to claim 1, wherein the storage device is further configured to store a password authentication application, implemented to authenticate the user account and allow a user to enter the system.

9. The system according to claim 1, wherein the mode selection item is a drop-down list providing options for selecting different recognition modes to recognize different type of characters in the password.

10. A method for password entry using a touch screen, the method comprising:
displaying a password input interface, the password input interface having a first field for entering a user account, a second field for entering a preset password corresponding to the user account;
receiving first inputs from the touch screen for entering user account name into the first field;
displaying residual imprints or trace images converted from the first inputs corresponding to the user account name;
receiving second inputs from the touch screen for entering password into the second field; and
disguising residual imprints or trace characters converted from the second inputs.

11. The method according to claim 10, further comprising:
completely disabling display of residual imprints or trace characters converted from the second inputs for entering the password.

12. The method according to claim 10, wherein the password input interface further comprises a mode selection item, the method further comprising:
activating the mode selection item to select an alphabet mode; and
recognizing a first portion of alphabet characters in the password only from an alphabet database.

13. The method according to claim 10, further comprising:
activating the mode selection item to select a numeric mode;
recognizing a second portion of numeric characters in the password only from a numeric character database.

14. The method according to claim 10, further comprising:
authenticating the password and allow a user to enter a system that is capable of implementing the method.

15. A method for recognizing characters in a password, the method comprising:
receiving inputs from an input device;
activating a first mode for selecting first type of characters most matching a first portion of the inputs from a first character database; and
activating a second mode for selecting second type of characters most matching a second portion of the inputs from a second character database.

16. The method according to claim 15, wherein the first character database is an alphabet character database.

17. The method according to claim 15, wherein the second character database is a numeric character database.

18. The method according to claim 15, further comprising disguising residual imprints or trace characters converted from the first portion of the inputs for entering the password.

19. The method according to claim 15, further comprising completely disabling the residual imprints or trace characters converted from the second portion of the inputs for entering the password.

20. The method according to claim 15, further comprising authenticating the password and allowing a user to enter the system.
